(19) United States
(12) Patent Application Publication
(10) Pub. No.: US 2025/0149747 A1
(43) Pub. Date: May 8, 2025

(54) LITHIUM SECONDARY BATTERY

(71) Applicants: Hyundai Motor Company, Seoul (KR); Kia Corporation, Seoul (KR)

(72) Inventors: Yeongjun Cheon, Hwaseong-si (KR); Youngmoo Jeon, Hwaseong-si (KR)

(21) Appl. No.: 18/825,063

(22) Filed: Sep. 5, 2024

(30) Foreign Application Priority Data
Nov. 2, 2023 (KR) 10-2023-0150261

(51) Int. Cl. H01M 50/507; H01M 4/02; H01M 4/38; H01M 50/289; H01M 50/588

(52) U.S. Cl. CPC H01M 50/507; H01M 4/382; H01M 50/289; H01M 50/588; H01M 2004/027

(57) ABSTRACT

An embodiment lithium secondary battery includes battery cells stacked in a cell cover, electrode leads electrically connected to the battery cells, busbar units connected to the electrode leads and configured to electrically connect the battery cells, guide rails disposed outside the battery cells and configured to support the busbar units such that the busbar units are movable in a stacking direction of the battery cells, and nonconductors disposed on the guide rails between the guide rails and the busbar units.

### CROSS-REFERENCE TO RELATED APPLICATIONS

This application claims the benefit of Korean Patent Application No. 10-2023-0150261, filed on Nov. 2, 2023, which application is hereby incorporated herein by reference.

### TECHNICAL FIELD

The present disclosure relates to a lithium secondary battery.

### BACKGROUND

A lithium secondary battery may have a high energy density and store electrical energy with a small volume and weight. Therefore, lithium secondary batteries are widely used as key energy storage devices for portable electronic devices or mobile electric vehicles. Because the lithium secondary battery has high charging and discharging efficiency, the lithium secondary battery may cause a low loss of energy and be stably used for a long period of time while maintaining performance even though the lithium secondary battery is repeatedly charged and discharged with various cycles.

However, the lithium secondary battery may change in volume during the charging and discharging processes. During the charging process, lithium ions are recombined in a positive electrode, and electrical energy is accumulated in lithium metal. Therefore, the lithium metal expands from the positive electrode and increases in size, which increases a volume of the battery during the charging process. The change in volume of the battery cell during the charging/discharging process is larger than that in a lithium-ion battery. In particular, when the lithium secondary battery operates over a long period of time, gases are generated in the battery cell because of electrolyte reactions and positive electrode degradation, and a porous lithium layer consistently grows because of a growth of dendritic lithium. For this reason, as the battery cell reaches the warranty lifespan, the volume of the battery cell significantly increases in comparison with an initial thickness, and the change in volume may physically deform internal components of the battery, which may affect the lifespan and stability of the battery.

Therefore, there is a need for research on technologies to improve stability of the lithium secondary battery.

### SUMMARY

The present disclosure relates to a lithium secondary battery. Particular embodiments relate to a lithium secondary battery having a structure for preventing a short circuit of a module lead of a battery.

Embodiments of the present disclosure provide a lithium secondary battery having a structure for preventing a short circuit of a module lead, in which even though a volume changes during a charging process, an electrode lead moves along a guide rail, and a structure is provided in which a nonconductor blocks a current when the volume exceeds a predetermined volume, such that the module lead of the lithium secondary battery is prevented from being short-circuited, thereby improving stability.

In order to achieve the above-mentioned features, embodiments of the present disclosure may include the following embodiments.

A lithium secondary battery according to an exemplary embodiment of the present disclosure includes a plurality of battery cells stacked in a cell cover, electrode leads electrically connected to the plurality of battery cells, busbar units connected to the electrode leads and configured to electrically connect the plurality of battery cells, guide rails positioned outside the plurality of battery cells and configured to support the busbar units so that the busbar units are movable in a stacking direction of the battery cells, and a plurality of nonconductors disposed on the guide rails, in which the plurality of nonconductors is positioned between the guide rails and the busbar units.

In addition, when the lithium secondary battery is charged, the busbar unit may linearly move along the guide rail in a direction in which thicknesses of the plurality of battery cells are changed, such that the electrode lead is prevented from being short-circuited.

In addition, the guide rail may be positioned outside the plurality of battery cells and fixed to the cell cover configured to support the battery cells.

In addition, the guide rail may include upper and lower rails extending in the stacking direction of the battery cells.

In addition, the busbar unit may include a busbar assembled to be linearly movable between the upper rail and the lower rail.

In addition, the busbar may include upper and lower sliders linearly movably inserted into the upper and lower rails and a lead assembling part provided between the upper and lower sliders.

In addition, the lead assembling part may have an insertion hole into which the electrode lead is inserted.

In addition, a surface pressure pad may be inserted between the plurality of battery cells.

In addition, the plurality of battery cells may each include a lithium metal negative electrode.

In addition, when the lithium secondary battery is charged, the busbar unit may linearly move along the guide rail in a direction in which thicknesses of the plurality of battery cells are changed, and when the busbar unit and the nonconductor are joined, no current may flow between the busbar and the guide rail.

According to the lithium secondary battery according to the embodiments of the present disclosure, the busbar unit linearly moves along the guide rail in the direction in which the thicknesses of the plurality of battery cells are changed during the charging process, and the busbar unit and the nonconductor are joined, such that no current flows between the busbar and the guide rail, which may prevent a short circuit of the module lead and improve stability of the lithium secondary battery.

### BRIEF DESCRIPTION OF THE DRAWINGS

The following drawings attached to the present specification illustrate exemplary embodiments of the present disclosure and serve to aid in further understanding of the technical spirit of the present disclosure together with the following detailed description of the present disclosure, and the embodiments of the present disclosure should not be interpreted as being limited to the items illustrated in the drawings.

FIG. 1 is a view illustrating a lithium secondary battery according to an embodiment of the present disclosure.

FIG. 2 is a perspective view illustrating a state in which the lithium secondary battery according to an embodiment of the present disclosure is assembled.

FIG. 3 is an enlarged perspective view of part A of the lithium secondary battery in FIG. 2 according to an embodiment of the present disclosure.

FIG. 4 is a perspective view illustrating an operation of the lithium secondary battery according to an embodiment of the present disclosure when a current is applied.

FIG. 5 is a perspective view illustrating an operation of a nonconductor of the lithium secondary battery according to an embodiment of the present disclosure when a current is not applied.

FIG. 6 is a graph illustrating a change in cell volume over time when the lithium secondary battery according to an embodiment of the present disclosure operates.

FIG. 7 is a view illustrating a position movement of a busbar in accordance with expansion of a cell volume when the lithium metal battery according to an embodiment of the present disclosure operates.

### DETAILED DESCRIPTION OF ILLUSTRATIVE EMBODIMENTS

Exemplary embodiments of the present disclosure will be described with reference to the accompanying drawings to sufficiently understand the present disclosure. In this case, the exemplary embodiments to be described below are illustrative for helping understand the present disclosure, and it should be understood that the present disclosure may be carried out by being modified in various ways different from the exemplary embodiments described herein. In addition, to help understand the present disclosure, the accompanying drawings are not illustrated based on actual scales, but some constituent elements may be exaggerated in dimension.

Hereinafter, a lithium secondary battery according to exemplary embodiments of the present disclosure will be described in detail with reference to the accompanying drawings.

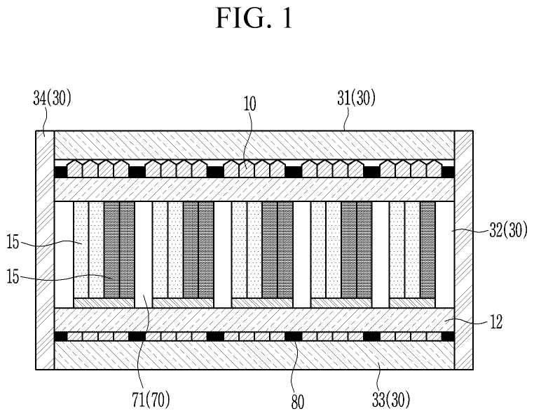

FIG. 1 is a view illustrating a lithium secondary battery according to an embodiment of the present disclosure. With reference to FIG. 1, the lithium secondary battery according to the embodiment of the present disclosure is supported by a plurality of battery cells 10 stacked in a cell cover 30.

The cell cover 30 includes right and left covers 32 and 34 disposed at two opposite left and right sides of the battery cells 10 and upper and lower covers 31 and 33 disposed at two opposite upper and lower sides of the battery cells. The right cover 32 and the left cover 34 are disposed at outermost sides based on a stacking direction of the battery cells 10. The right cover 32, the left cover 34, the upper cover 31, and the lower cover 33 are coupled to one another and positioned outside the battery cells 10 to support and maintain the stacked state of the battery cells 10.

The lithium secondary battery includes electrode leads 15 electrically connected to the plurality of battery cells 10, busbar units 70 connected to the electrode leads 15 and configured to electrically connect the plurality of battery cells 10, guide rails 12 positioned outside the plurality of battery cells 10 and configured to support the busbar units 70 so that the busbar units 70 are movable in the stacking direction of the battery cells 10, and a plurality of nonconductors 300 disposed on the guide rails 12. The nonconductors 300 are positioned between the guide rails 12 and the busbar units 70.

When a volume expands as the battery cells 10 are charged or discharged, the positions of the electrode leads 15 move along the guide rails 12 in the stacking direction of the battery cell 10. This is because the electrode leads 15 are joined to the battery cells 10. The electrode lead 15 is joined and connected to a negative electrode tab or a positive electrode tab among the electrode tabs provided at two opposite front and rear sides of the battery cells 10. At the time of charging the lithium secondary battery, the busbar unit 70 linearly moves along the guide rail 12 in a direction in which thicknesses of the plurality of battery cells 10 are changed, such that the electrode lead 15 is prevented from being short-circuited.

The guide rail 12 may be fixed to the cell cover 30 positioned outside the plurality of battery cells 10 and configured to support the battery cells 10. The guide rail 12 may include upper and lower rails 13 and 14 extending in the stacking direction of the battery cells 10.

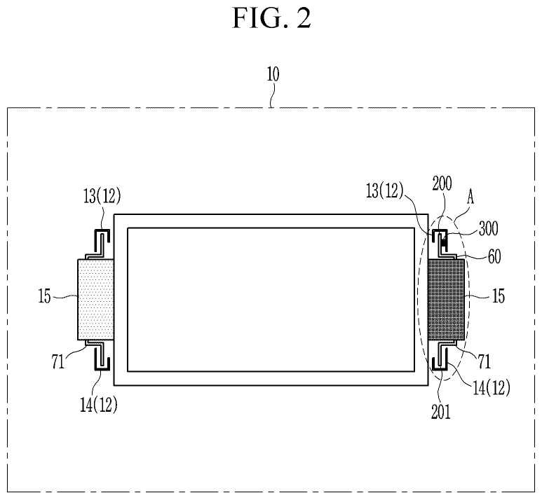

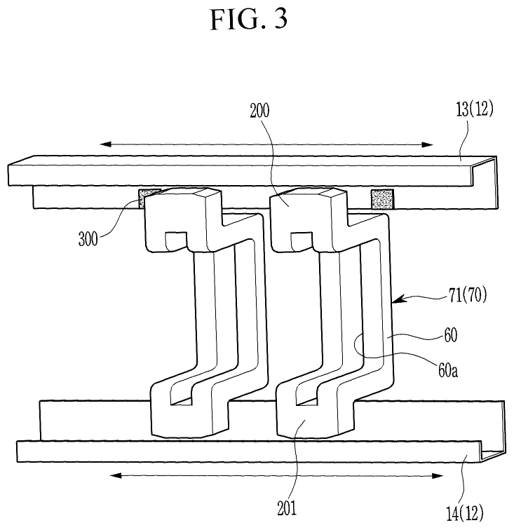

FIG. 2 is a perspective view illustrating a state in which the lithium secondary battery according to an embodiment of the present disclosure is assembled, and FIG. 3 is an enlarged perspective view of part A of the lithium secondary battery in FIG. 2 according to an embodiment of the present disclosure.

With reference to FIGS. 2 and 3, the upper rail 13 and the lower rail 14 are spaced apart from each other in an upward/downward direction and disposed to face each other. The upper rail 13 and the lower rail 14 each have a cross-sectional structure having an approximately ⊏ shape.

The busbar unit 70 may include a plurality of busbars 71 assembled to be linearly movable between the upper rail 13 and the lower rail 14. The busbar 71 may include upper and lower sliders 200 and 201 linearly movably inserted into the upper and lower rails 13 and 14 and a lead assembling part 60 provided between the upper slider 200 and the lower slider 201.

The lead assembling part 60 may have a curved structure having a E shape. The upper slider 200 and the lower slider 201 may be integrally formed at two opposite ends of the lead assembling part 60. The lead assembling part 60 may have an insertion hole 60a into which the electrode lead 15 is inserted.

The electrode lead 15 is inserted into the insertion hole 60a and connected to the busbar 71, and one end of the electrode lead 15 penetrates the insertion hole 60a and protrudes to the outside of the lead assembling part 60.

The busbar unit 70 includes the plurality of busbars 71 individually assembled to the guide rail 12. Therefore, when the battery cells 10 expand in volume, some of the busbars 71 may move to one side (e.g., left) in the cell stacking direction, and the remaining busbars 71 may move to the other side (e.g., right) in the cell stacking direction.

The busbars 71 are respectively connected to the electrode leads 15 of the battery cells 10 and electrically connect the battery cells 10. In addition, the plurality of busbars 71 are electrically connected by the guide rail 12, and the guide rail 12 is made of a material having electrical conductivity.

With reference to FIG. 1, surface pressure pads 80 may be inserted between the plurality of battery cells 10. The surface pressure pads 80 are selectively inserted between the battery cells 10, and one or more surface pressure pads 80 are inserted into the lithium secondary battery. The surface pressure pad 80 is compressed in the cell stacking direction when the battery cells 10 expand in volume as the battery cells 10 are charged or discharged. The plurality of battery cells 10 may include lithium metal negative electrodes.

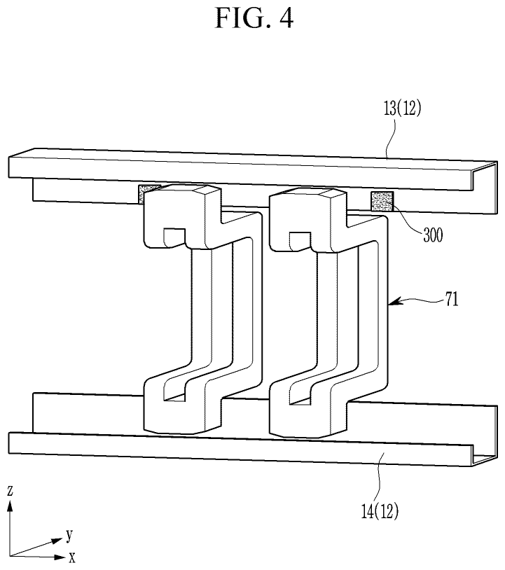

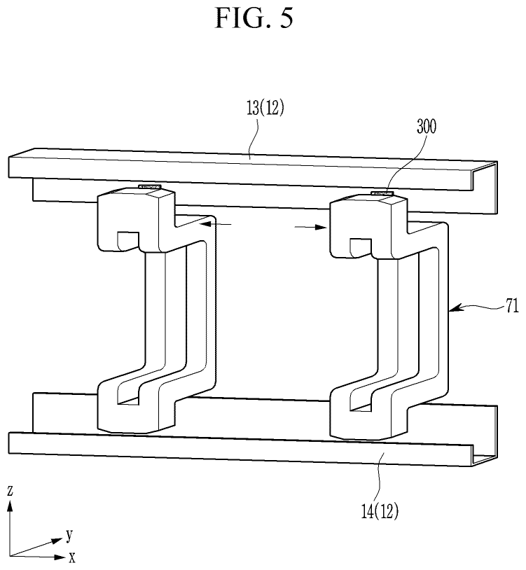

FIG. 4 is a perspective view illustrating an operation of the lithium secondary battery according to an embodiment of the present disclosure when a current is applied, and FIG. 5 is a perspective view illustrating an operation of a nonconductor of the lithium secondary battery according to an embodiment of the present disclosure when a current is not applied.

With reference to FIGS. 4 and 5, when the cells expand and change in volume as the lithium secondary battery operates, the nonconductor 300 needs to be disposed at the middle of the busbar 71 to prevent the application of electricity in order to prevent a short circuit of the module lead of the lithium secondary battery. At the time of charging the lithium secondary battery, the busbar unit 70 moves linearly along the guide rail 12 in the direction in which the thicknesses of the plurality of battery cells 10 are changed, and the busbar unit 70 and the nonconductor 300 are joined, such that the current does not flow between the busbar 71 and the guide rail 12, thereby preventing a short circuit of the module lead of the lithium secondary battery.

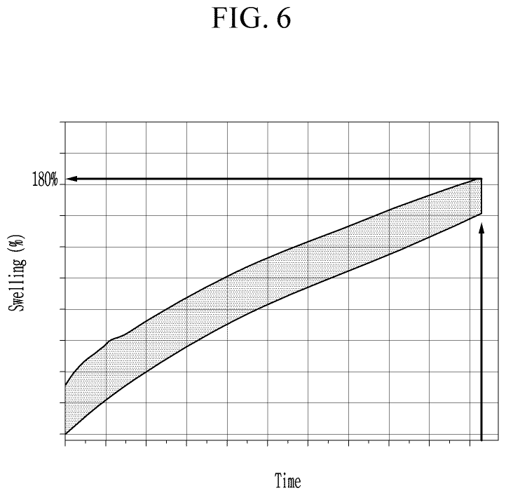

FIG. 6 is a graph illustrating a change in cell volume over time when the lithium secondary battery according to an embodiment of the present disclosure operates.

With reference to FIG. 6, it can be ascertained that in the case of the lithium secondary battery, when the volume exceeds 180% when the cells operate, the busbar unit 70 and the nonconductor 300 are joined, such that the current does not flow between the busbar 71 and the guide rail 12, which prevents a short circuit of the module lead of the lithium secondary battery.

Meanwhile, in the case of the battery cell including the lithium metal negative electrode, the volume of the negative electrode greatly changes during the charging/discharging process in comparison with the battery cell including a graphite negative electrode. Therefore, the overall cell thickness also increases. In the case of the lithium metal battery, the change in volume for each cell is much larger than that of the lithium-ion battery, which increases a risk of the occurrence of the movement of the electrode lead and a risk of a short circuit.

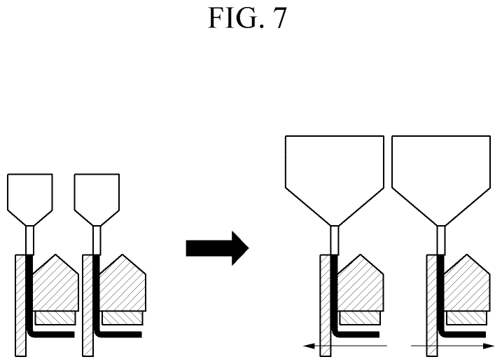

FIG. 7 is a view illustrating a position movement of a busbar in accordance with expansion of a cell volume when the lithium metal battery according to the embodiment of the present disclosure operates.

With reference to FIG. 7, as in the embodiments of the present disclosure, when the structure for preventing a short circuit of a lead is applied to the lithium metal battery, the position of the busbar moves in accordance with the change in volume for each cell, as illustrated in the right view in FIG. 7. When the cell volume changes while exceeding 180%, the current is blocked as the nonconductor and the busbar are joined, which is more effective in preventing a short circuit of the electrode lead and a fracture of the cell internal configuration.

The above-mentioned embodiments of the lithium secondary battery capable of preventing a short circuit of the electrode module are for illustrative purposes only, and those skilled in the art to which the present technology pertains will understand that various modifications of the embodiments and other embodiments equivalent thereto are available.

Accordingly, the true technical protection scope of the present disclosure should be determined by the technical spirit of the appended claims. In addition, it should be understood that the present disclosure includes all modifications, equivalents, and substitutes within the spirit and scope of the present disclosure defined by the appended claims.

The following reference identifiers may be used in connection with the drawings to describe various features of embodiments of the present disclosure.

| | |
|---|---|
| 10: Battery cell | 12: Guide rail |
| 13: Upper rail | 14: Lower rail |
| 15: Electrode lead | 30: Cell cover |
| 31: Upper cover | 32: Right cover |
| 33: Lower cover | 34: Left cover |
| 60: Lead assembling part | 60a: Insertion hole |
| 70: Busbar unit | 71: Busbar |
| 80: Surface pressure pad | 200: Upper slider |
| 201: Lower slider | 300: Nonconductor |

What is claimed is:

1. A lithium secondary battery comprising:
a plurality of battery cells stacked in a cell cover;
electrode leads electrically connected to the battery cells;
busbar units connected to the electrode leads and configured to electrically connect the battery cells;
guide rails disposed outside the battery cells and configured to support the busbar units such that the busbar units are movable in a stacking direction of the battery cells; and
a plurality of nonconductors disposed on the guide rails between the guide rails and the busbar units.

2. The lithium secondary battery of claim 1, wherein, in a state in which the lithium secondary battery is charged, the busbar units are configured to move linearly along the guide rails in a direction in which thicknesses of the battery cells are changed in a manner that the electrode leads are prevented from being short-circuited.

3. The lithium secondary battery of claim 1, wherein the guide rails are fixed to the cell cover, and wherein the cell cover is configured to support the battery cells.

4. The lithium secondary battery of claim 1, wherein the guide rails each comprise an upper rail and a lower rail extending in the stacking direction of the battery cells.

5. The lithium secondary battery of claim 4, wherein the busbar units each comprise a busbar assembled to be movable linearly between the upper rail and the lower rail.

6. The lithium secondary battery of claim 5, wherein the busbar comprises:
an upper slider and a lower slider inserted into the upper rail and the lower rail to be movable linearly; and
a lead assembling part disposed between the upper slider and the lower slider.

7. The lithium secondary battery of claim 6, wherein the lead assembling part comprises an insertion hole configured to receive the electrode leads.

8. The lithium secondary battery of claim 1, further comprising a surface pressure pad disposed between the battery cells.

9. The lithium secondary battery of claim 1, wherein the battery cells each comprise a lithium metal negative electrode.

10. The lithium secondary battery of claim 1, wherein, in a state in which the lithium secondary battery is charged, the busbar units are configured to move linearly along the guide rails in a direction in which thicknesses of the battery cells are changed to a position at which the busbar units and the nonconductors are joined.

11. The lithium secondary battery of claim 10, wherein no current flows between the busbar units and the guide rails at the position at which the busbar units and the nonconductors are joined.

12. A lithium secondary battery comprising:
battery cells stacked in a cell cover;
electrode leads electrically connected to the battery cells;
a busbar unit connected to the electrode leads and configured to electrically connect the battery cells, wherein the busbar unit comprises a plurality of busbars respectively connected to the electrode leads;
guide rails disposed outside the battery cells and fixed to the cell cover, the guide rails each comprising an upper rail and a lower rail extending in a stacking direction of the battery cells, wherein the guide rails are configured to support the busbar unit such that the busbar unit is movable along the stacking direction of the battery cells, and wherein the busbars are individually assembled to the guide rails such that, in a state in which the battery cells expand in volume, a first subset of the busbars is configured to move to a first side in the stacking direction of the battery cells and a second subset of the busbars is configured to move to a second side in the stacking direction of the battery cells; and
nonconductors disposed on the guide rails between the guide rails and the busbar unit.

13. The lithium secondary battery of claim 12, wherein, in a state in which the lithium secondary battery is charged, the busbar unit is configured to move linearly along the guide rails in a direction in which thicknesses of the battery cells are changed in a manner that the electrode leads are prevented from being short-circuited.

14. The lithium secondary battery of claim 12, wherein the upper rail and the lower rail each have a cross-sectional structure having an approximately ⊏ shape.

15. The lithium secondary battery of claim 12, wherein the busbars are assembled to be movable linearly between the upper rail and the lower rail.

16. The lithium secondary battery of claim 12, wherein the busbars each comprise:
an upper slider and a lower slider inserted into the upper rail and the lower rail, respectively, and configured to be movable linearly; and
a lead assembling part disposed between the upper slider and the lower slider.

17. The lithium secondary battery of claim 16, wherein the lead assembling part comprises an insertion hole configured to receive a respective electrode lead of the electrode leads.

18. The lithium secondary battery of claim 12, further comprising surface pressure pads selectively inserted between the battery cells.

19. The lithium secondary battery of claim 12, wherein the battery cells each comprise a lithium metal negative electrode.

20. The lithium secondary battery of claim 12, wherein:
in a state in which the lithium secondary battery is charged, the busbars are configured to move linearly along the guide rails in a direction in which thicknesses of the battery cells are changed to positions at which the busbars and the nonconductors are joined; and
no current flows between the busbars and the guide rails at the positions at which the busbars and the nonconductors are joined.
